(19) United States
(12) Patent Application Publication
(10) Pub. No.: US 2026/0116690 A1
(43) Pub. Date: Apr. 30, 2026

(54) DEVICE FOR CONNECTING MATERIAL WEBS FOR THE PRODUCTION OF ENERGY CELLS

(71) Applicant: KÖRBER TECHNOLOGIES GMBH, HAMBURG (DE)

(72) Inventors: Matthias HORN, AHRENSBURG (DE); Karl Richard BUSCH, HAMBURG (DE); Axel HENNING, OSTSTEINBEK (DE); Frank GROTHAUS, PAPENBURG (DE)

(21) Appl. No.: 19/116,214

(22) PCT Filed: Sep. 22, 2023
(86) PCT No.: PCT/EP2023/076256

§ 371 Date: Mar. 27, 2025

(30) Foreign Application Priority Data
Oct. 4, 2022 (DE) 10 2022 125 536.0

(51) Int. Cl. B65H 19/10; B65H 19/18; B65H 21/00; H01M 10/04

(52) U.S. Cl. CPC B65H 19/102; B65H 19/1826; B65H 21/00; H01M 10/0409; B65H 2301/46172; B65H 2301/4622; B65H 2301/4641; B65H 2801/72

(57) ABSTRACT

The invention relates to a device for joining webs of material for the production of energy cells, in particular electrode webs, wherein a running-out web of material can be joined to a new web of material. A first pivoting element is provided for the new web of material and a second pivoting element is provided for the running-out web of material, wherein the first pivoting element is adapted to hold the leading end of the new web of material and wherein the second pivoting element is adapted to deflect the running-out web of material in the direction of the first pivoting element. A cutting device is provided, which is adapted to cut or weaken the running-out web of material deflected by the second pivoting element to produce a web end of the running-out web of material at a separating line. The device is adapted to accelerate the leading end of the new web of material with the first pivoting element and to synchronize with the running-out web of material at the speed at which the web end of the running-out web of material deflected by the second pivoting element is conveyed. The leading end of the new web of material can be joined to the web end of the running-out web of material between the first and second pivoting elements by means of at least one adhesive tape.

The present invention relates to a device for joining webs of material for the production of energy cells, in particular electrode webs, according to the preamble of claim 1, as well as a corresponding method according to the preamble of claim 17.

Energy cells or energy storage devices in the sense of the invention are used, for example, in motor vehicles, other land vehicles, ships, aircraft or also in stationary systems, such as in the form of battery cells or fuel cells, in which very large amounts of energy have to be stored over long periods of time. For this purpose, such energy cells comprise a structure of layered materials, which usually consist of an anode material on a conductor foil and a cathode material on a conductor foil and a separator foil, wherein the separator foil is arranged between the anode material and the cathode material. Such a material composite can be present in an energy cell in a stacked, rolled or folded arrangement.

To achieve a high production speed, the materials for the anode, cathode and separator are processed as webs of material as far as possible. These webs of material, which may be semi-finished or also intermediate products, are usually supplied as bobbins or coils or transported between different systems in this form. Bobbins inevitably comprise a limited length of web. To maximize the production rate and thus minimize production costs, it is advantageous to have a continuous production process with a high speed and an endless web, so that each running-out web of material is connected to new webs of material. To ensure continuous production, process storages or buffer storages are known, which represent a buffer so that the connection of two webs of material can be produced to achieve an endless web, while the further production process is carried out with the web of material from the buffer storage. However, increasing production speeds in the manufacture of energy cells, for example Li-ion batteries, cannot be compensated for by ever larger buffer storages, so that the connection process should be carried out preferably dynamically during the conveying, for example at production speed, in order to be able to design the buffer storage as small as possible or to do completely without a buffer storage. Doing without buffer storage reduces the space required for a facility and also offers potential for cost savings.

Therefore, the object of the invention is to provide a device and a method that enable an as fast and efficient connection of webs of material as possible.

The object is solved by the features of the independent claims. Further preferred embodiments of the invention are set forth in the dependent claims, figures and description relating thereto.

A device for joining webs of material for the production of energy cells, in particular electrode webs, wherein a running-out web of material can be joined to a new web of material, is proposed. It is proposed that a first pivoting element for the new web of material and a second pivoting element for the running-out web of material are provided, wherein the first pivoting element is adapted to hold the leading end of the new web of material and the second pivoting element is adapted to deflect the running-out web of material in the direction of the first pivoting element. A cutting device is provided, which is adapted to cut or weaken the running-out web of material deflected by the second pivoting element to produce a web end of the running-out web of material at a separating line. The device is adapted to accelerate the leading end of the new web of material with the first pivoting element and to synchronize with the running-out web of material, preferably in a joining section, at the speed at which the web end of the running-out web of material deflected by the second pivoting element is conveyed. The leading end of the new web of material can be joined to the web end of the running-out web of material between the first and second pivoting elements by means of at least one adhesive tape.

The proposed device makes it possible to join two webs of material for the production of an energy cell, in particular a battery cell, for example a lithium-ion battery, wherein the conveying speed can be maintained during the joining process. Preferably, the two webs of material are joined in a joining section in which the two webs of material are conveyed at the same or synchronous speed. For continuous provision of a web of material, for example an electrode web, i.e. a conductor foil coated with anode or cathode material, the proposed device can be used to omit a buffer storage or process storage.

In an advantageous embodiment, the leading end of the new web of material and the web end of the running-out web of material are joinable one behind the other between the first and second pivoting element.

The webs of material can therefore preferably be joined without overlapping. The webs of material joined by the at least one adhesive tape therefore preferably lie edge to edge. With the proposed device, a dynamic splice of the webs of material can be achieved without significant thickening of the web of material. The increase in thickness at the splice results only from the adhesive tape. This can avoid possible disruptions that may occur in subsequent processes due to the increase in material thickness in the splice area with an overlap. The proposed device is therefore particularly suitable for relatively thick webs of material of an energy cell, such as electrode webs.

According to an advantageous further development, it is proposed that the first pivoting element and the second pivoting element roll against each other in a joining section, wherein the new web of material and the running-out web of material are arranged one behind the other and are each arranged between the first pivoting element and the second pivoting element.

This enables the webs of material to be guided advantageously between the pivoting elements. Furthermore, a contact pressure or a counter-bearing for the application of the at least one adhesive tape can be easily realized.

Furthermore, according to an advantageous further development, it is proposed that the second pivoting element is adapted to deflect the running-out web of material in a non-slip manner. The movement of the second pivoting element is therefore preferably synchronized with the speed of the running-out web of material.

It is further proposed that the second pivoting element is adapted to press the running-out web of material against the first pivoting element during deflection. The deflection can, for example, ensure that the running-out web of material is well positioned on the contact surface of the second pivoting element.

In an advantageous embodiment, the running-out web of material can be clamped between the first pivoting element and the second pivoting element, while the running-out web of material can be conveyed further in a conveying direction.

The clamp prevents the webs of material from moving relative to the two pivoting elements, while the pivoting elements roll against each other at the same speed as the web of material is conveyed. This is advantageous for the application of the adhesive tape(s) between the leading end of the new web of material and the web end of the running-out web of material, since, despite the continuing conveyance of the webs of material, there is no relative movement between the pivoting elements, which pivot in synchronization with the webs of material, and the webs of material.

In an advantageous embodiment, the second pivoting element is a counter-holder for the running-out web of material when it is cut or weakened by the cutting device.

The second pivoting element can thus displace the running-out web of material towards the cutting device and can simultaneously be used as a counter-holder for cutting off the rest of the running-out web of material.

According to a further development, it is proposed that the cutting device is a knife roller which, during cutting or weakening, runs synchronously on the second pivoting element, wherein the running-out web of material runs between the second pivoting element and the cutting device.

This means that the rotatable knife roller can be arranged in a stationary manner in the device, while the running-out web of material is displaced by the second pivoting element towards the knife roller.

The second pivoting element preferably serves as a counter-bearing for the knife roller. This is facilitated by a possible non-slip deflection of the running-out web of material during the conveying by the second pivoting element, which pivots synchronized with the knife roller.

Furthermore, it is proposed that the running-out web of material runs off a bobbin which is arranged on a bobbin holder, wherein the device is adapted to slow down the bobbin after weakening the running-out web of material at the separating line in relation to the conveying speed.

The weakening of the running-out web of material can, for example, be a perforation at the separating line. As a result, the running-out web of material can be separated at the produced separating line at a later point in time after producing the weakening at the separating line by increasing the tensile stress in the running-out web of material. The increase in tensile stress can be achieved in particular by relatively slowing down the bobbin with the running-out web of material compared to the conveying speed. The separation at the separating line by slowing down the bobbin is particularly advantageous when the running-out web of material is clamped between the two pivoting elements, which preferably pivot at the conveying speed and roll against each other. The separation preferably occurs before the separating line comes into contact with one of the two pivoting elements.

In a further advantageous embodiment, a bobbin opener is arranged on the first pivoting element, which is adapted to open a bobbin with a new web of material and to pick up the leader of the new web of material from the bobbin.

Preparation for the dynamic joining of the webs of material can therefore be carried out automatically, whereby a fully automatic process for joining two webs of material can be achieved.

It is also proposed that a pretensioning element be provided for rolling up and tensioning the leader of the new web of material.

The pretensioning element can be used to wind up the leader of the new web of material, for example with a wrapping paper or a first layer, and to remove it accordingly. Furthermore, the pretensioning element can be used to wind up the rest of the new web of material after it has been cut by the cutting unit at the separating line and also to remove it. Furthermore, the pretensioning element can preferably take over the new web of material from the bobbin opener of the first pivoting element.

According to a further development, it is proposed that the device comprises a cutting unit and a backing element, wherein the cutting unit and the backing element are adapted to cut the new web of material to produce the leading end of the new web of material.

This makes it possible to cut the new web of material at the first pivoting element while the new web of material is in contact with the first pivoting element. The cutting element and the backing element are preferably mounted independently of the first pivoting element, so that they cannot be pivoted with the pivoting element. Accordingly, the first pivoting element can be constructed in a simpler way, which reduces the mass that is moved. The cutting element and the backing element are preferably movable into the plane of the webs of material, for example from a rear wall of the device. The first pivoting element is preferably pivotable with the new web of material to the position of the cutting element and the backing element, so that the cutting element with the backing element can cut or sufficiently weaken the new web of material.

The cutting unit is preferably arranged in a recess in a contact surface for the webs of material of the first pivoting element.

The recess in the contact surface for the web of material is accordingly at least partially covered by an adjacent web of material. The contact surface for the webs of material of the first pivoting element preferably corresponds with the contact surface of the second pivoting element, so that the first and second pivoting elements can roll against each other with the contact surfaces, wherein a web of material can be arranged in the intermediate space.

In advantageous embodiments, the cutting unit can be moved in particular into the recess of the first pivoting element from a plane outside the path of the webs of material. Furthermore, when cutting the new web of material, the cutting unit moves preferably perpendicular to the pivoting axis of the first pivoting element in a radially outward direction. The backing element is preferably stationary during the cutting process and rests on the side of the new web of material facing away from the first pivoting element.

The leading end therefore preferably rests against the backing element after the cutting process and further preferably covers at least part of the recess. In an advantageous embodiment, the new web of material can also be fixed between portions of the contact surface of the first pivoting element and portions of the backing element.

Furthermore, it is proposed that an applicator for adhesive tape is arranged on the first pivoting element, which is radially displaceable perpendicular to the pivot axis of the first pivoting element.

The applicator is preferably arranged on the first pivoting element. Furthermore, the applicator is preferably arranged in a recess in the contact surface for the webs of material in the first pivoting element. This makes it possible to apply part of an adhesive tape to the leading end of the new web of material created by the cutting. The backing element can also be used as an abutment for the application of the adhesive tape. After the cutting process, the cutting unit is preferably moved out of the plane in which the webs of material are conveyed.

According to a further development, it is proposed that the applicator is arranged in a recess in a contact surface for the webs of material of the first pivoting element. The applicator can thus apply the adhesive tape to the leading end of the new web of material from one side. In a preferred embodiment, the applicator and the cutting unit are located in the same recess, wherein only the applicator is connected to the pivoting element and the cutting unit can be moved into the recess.

It is also proposed that a supply unit for supplying adhesive tapes is provided, which is adapted to transfer adhesive tapes to the applicator. In particular, the adhesive tapes can be transferred to the applicator, which is arranged on the first pivoting arm, in a transfer position of the first pivoting element. The transfer of at least one adhesive tape from the supply unit can be done automatically, whereby the preparation measures for the dynamic joining of the webs of material can also run automatically.

Furthermore, a method for joining webs of material for the production of energy cells with a device according to any one of claims 1 to 16 is proposed for solving the object.

The invention is explained below with reference to preferred embodiments with reference to the accompanying figures. Therein shows

FIG. 1 a device for joining webs of material with a first pivoting element in a transfer position for adhesive tape;

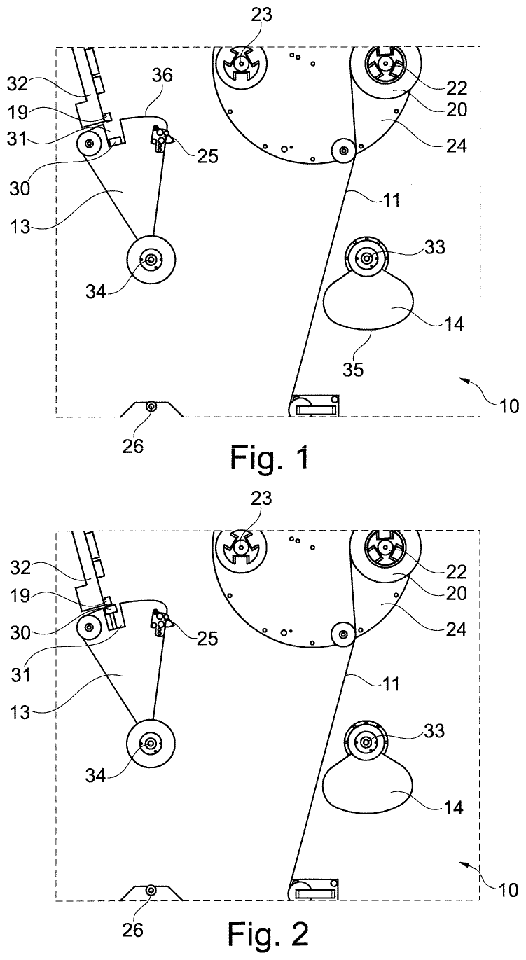

FIG. 2 a device for joining webs of material with an applicator in the first pivoting element when taking over an adhesive tape;

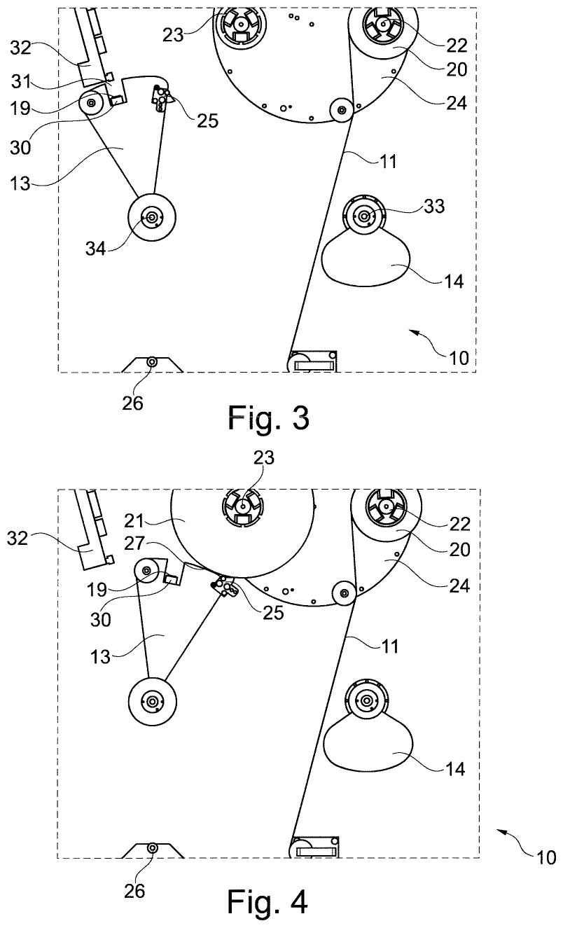

FIG. 3 a device for joining webs of material with an applicator with an adhesive tape taken over from a supply unit;

FIG. 4 a device for joining webs of material with a bobbin with a new web of material when the bobbin is opened by the first pivoting element;

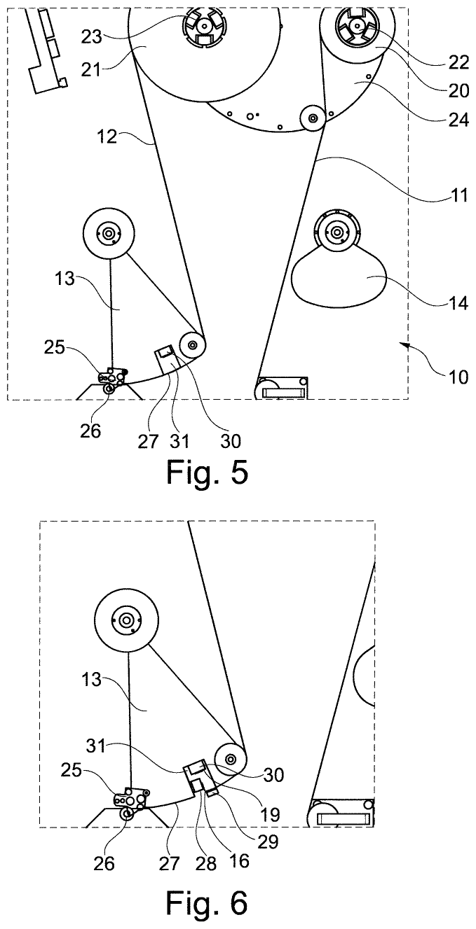

FIG. 5 a device for joining webs of material when transferring the new web of material to a pretensioning element;

FIG. 6 a section with a first pivoting element with a cutting unit and a backing element;

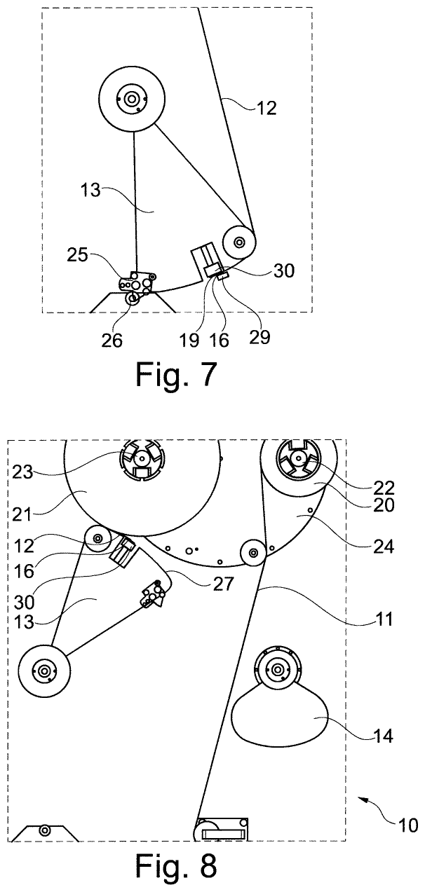

FIG. 7 a section with a first pivoting element when applying an adhesive tape to the leading end of the new web of material;

FIG. 8 a device for joining webs of material with a pivoting element for the new web of material in a waiting position;

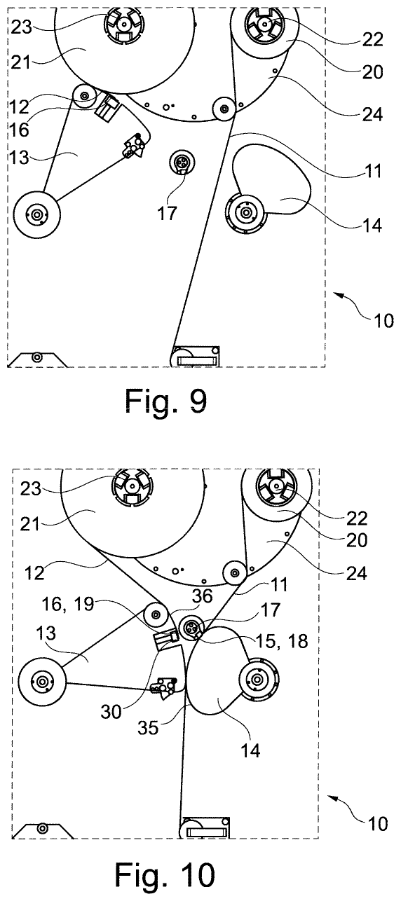

FIG. 9 a device for joining webs of material with a pivoting element in a waiting position and a knife roller out of the rear wall;

FIG. 10 a device for joining webs of material with accelerated pivoting elements;

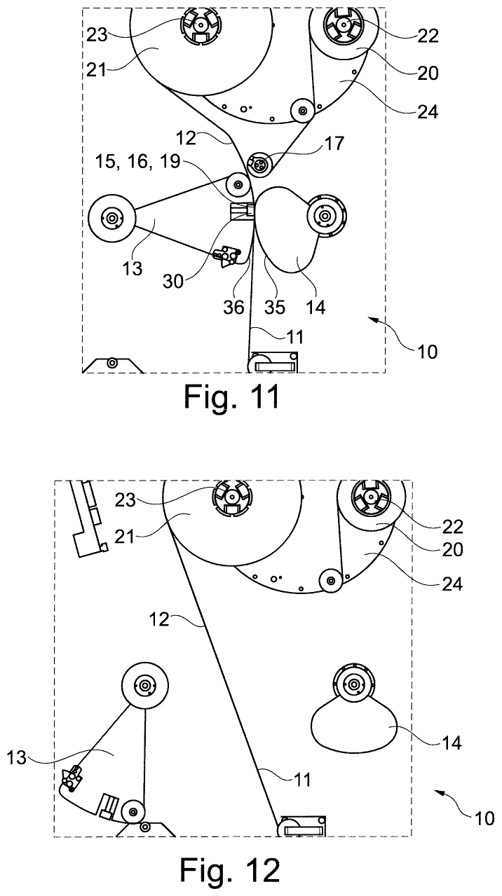

FIG. 11 a device for joining webs of material when producing an adhesive bond;

FIG. 12 a device for joining webs of material to a joined web of material;

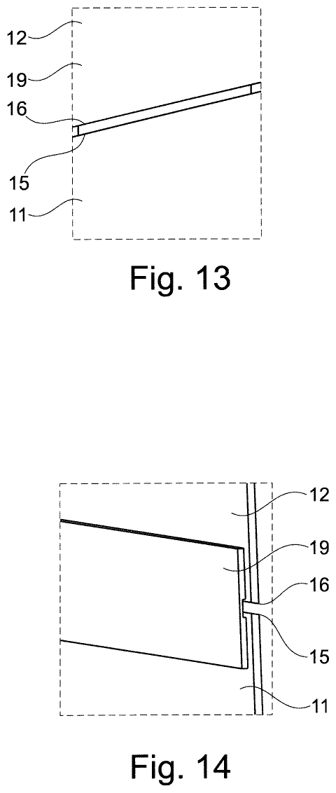

FIG. 13 a web of material joined with an adhesive tape from a rear side; and

FIG. 14 a web of material joined with an adhesive tape from a front side.

FIGS. 1 to 12 show an advantageous embodiment of a device 10 for joining webs of material 11, 12 for the production of energy cells. The webs of material 11, 12 are, for example, conductor foils coated with anode or cathode material.

FIG. 1 shows the running-out web of material 11 being conveyed from a bobbin 20 placed on a bobbin holder 22. The web of material 11 is conveyed at a conveying speed to a subsequent process for the production of an energy or battery cell. For the continuous conveying of an endless web of material 11, 12 to subsequent processes, the web of material 11 from the bobbin 20 is joined to a new web of material 12 before the end of the bobbin 20. The joining of the webs of material 11, 12 is preferably carried out at full conveying speed, so that no buffer storage or, in alternative embodiments, only a small buffer storage is required for the running-out web of material 11.

The device 10 comprises a first pivoting element 13 and a second pivoting element 14, which can each be rotated independently of one another about a pivot axis 33, 34 by means of servomotors. In the state shown in FIG. 1, the first pivoting element 13 is in a transfer position in which the first pivoting element 13 faces a supply unit 32 for adhesive tape 19. The first pivoting element 13 has a recess 31 in a curved contact surface 36 for the webs of material 11, 12. An applicator 30 is arranged in the recess 31 and can move in the first pivoting element 13 in the radial direction. In FIG. 1, the applicator 30 is in a retracted position.

The second pivoting element 14 also comprises a curved contact surface 35 for the webs of material 11, 12 and, in the illustration in FIG. 1, is in a position in which the second pivoting element 14 is not in contact with the running-out web of material 11.

In FIG. 2, the applicator 30 has moved radially out into a transfer position to take over an adhesive tape 19 from the supply unit 32, so that the adhesive tape 19 can be taken over by the applicator 30 preferably outside the recess 31.

The adhesive tape 19 has been taken over by the applicator 30 in FIG. 3 and is held, for example, by means of negative pressure. The applicator 30 with the adhesive tape 19 was retracted in a waiting position in the recess 31 in the direction of the pivot axis 34. The adhesive tape 19 is thus prepared for the joining of the webs of material 11, 12.

FIG. 4 shows a new bobbin 21 with the new web of material 12 on the bobbin holder 23, which is arranged together with the bobbin holder 22 with the running-out web of material 11 on a turntable 24.

The first pivoting element 13 comprises a bobbin opener 25, with which the bobbin 21 is opened and picked up. The bobbin opener 25 is arranged on the front part of the contact surface 36 or also in the conveying direction of the intended pivoting movement, so that a picked up web of material 12 from the bobbin 21 is guided over the curved contact surface 36 during a pivoting movement of the first pivoting element 13, which can be seen in FIG. 5.

FIG. 5 also shows how the new web of material 12 is transferred to a pretensioning element 26. The pretensioning element 26 can wind up the leader 27 of the new web of material 12 and, for example, dispose of wrapping paper or a first layer.

FIG. 6 shows a section of the process of cutting the new web of material 12 to produce a defined leading end 16 of the new web of material 12. From a rear plane of the device 10, a cutting unit 28 and a backing element 29 are moved into the path of the new web of material 12. The first pivoting element 13 is in a rotational position in which the cutting unit 28 can be inserted into the recess 31, while the applicator 30 with the adhesive tape 19 remains in the waiting position. The backing element 29 rests on the side of the web of material 12 that faces away from the recess 31.

The cutting unit 28 is then moved in the direction of the backing element 29 and the leader 27 of the new web of material 12 is cut off at the backing element 29. The cut-off leader 27 is wound up by the pretensioning element 26 and then disposed of.

In the next step, which is shown in FIG. 7, the applicator 30 applies the adhesive tape 19 to the leading end 16 of the new web of material 12, wherein the new web of material 12 only partially covers the adhesive tape 19. The backing element 29 serves as an abutment when the adhesive tape 19 is applied. Furthermore, after the new web of material 12 has been cut, the backing element 29 briefly serves as a fixing aid for the newly created leading end 16. The adhesive tape 19 and thus, in principle, the leading end 16 of the new web of material 12 can be held on the applicator 30, for example, by negative pressure.

In FIG. 8, the first pivoting element 13 is turned to a waiting position. The web of material 12 is wound back onto the bobbin 21 as far as necessary. The preparations of the new web of material 12 for joining with the running-out web of material 11 are therefore complete.

Furthermore, as shown in FIG. 9, a knife roller 17 is moved in from a rear plane, wherein the running-out web of material 11 runs between the knife roller 17 and the second pivoting element 14. The preparations of the device 10 for joining the new web of material 12 to the running-out web of material 11 are therefore complete. The splice can now be initiated on the basis of the unwound state of the bobbin 20 and in accordance with the remaining web length of the running-out web of material 11.

In this advantageous embodiment, the running-out web of material 12 can continue to be fed from the bobbin 20 to a subsequent process for manufacturing battery cells during these preparations.

FIGS. 10 and 11 show the actual process of joining the running-out web of material 11 to the new web of material 12 by means of the device 10.

In FIG. 10, the first and second pivoting elements 13, 14 accelerate, wherein the first pivoting element 13 also accelerates the leading end 16 with the adhesive tape 19 to the conveying speed. The second pivoting element 14 also accelerates and deflects the web of material 11, which is running out and is still being conveyed at the conveying speed, in the direction of the driven knife roller 17. The knife roller 17 cuts the deflected, running-out web of material 11 at a separating line 18, forming a web end 15 of the running-out web of material 11. The second pivoting element 14, which pivots at a synchronized speed with the running-out web of material 11, serves as a counter-bearing for the knife roller 17. The knife roller 17 and the two pivoting elements 13, 14 have a synchronous speed, e.g. the processing speed or the conveying speed of the web, at the moment of cutting or weakening at the separating line 18. In possible embodiments, the bobbin holder 22 can brake the bobbin 22 after separating or weakening at the separating line 18 by means of the knife roller 17, so that the running-out web of material 11 is separated at a weakening at the separating line 18.

Furthermore, in this advantageous embodiment, the running-out web of material 11 is clamped between the first and second pivoting elements 13, 14, wherein the running-out web of material 11 continues to be conveyed at the conveying speed. The contact surfaces 35, 36 roll on each other with the running-out web of material 11 in between during the synchronized pivoting movement of the first and second pivoting elements 13, 14.

FIG. 11 shows the device 10 a moment later. The first and second pivoting elements 13, 14 have pivoted further in the conveying direction, following the conveying direction of the running-out web of material 11. The web end 15 of the running-out web of material 11, which is produced by the knife roller 17, contacts the free area of the adhesive tape 19, the other part of which is bonded to the leading end 16 of the new web of material 12. The adhesive tape 19 is supported by the applicator 30, which generates a contact pressure on the adhesive tape 19 at the web end 16 of the running-out web of material 11 together with the contact surface 35 of the second pivoting element 14. The web end 15 of the running-out web of material 11 can therefore be joined to the leading end 16 of the new web of material 12 without overlapping.

The web of material 11, 12 joined by the adhesive tape 19 then runs off the bobbin 21, whereby the joining process and the change to the new web of material 12 is completed while the web of material 11, 12 is continuously conveyed, as shown in FIG. 12. Subsequently, the bobbin 21 with the new web of material 12 can be turned with the turntable 24 to the position of the bobbin 22, whereby the new web of material 12 finally becomes the running-out web of material 11 and an endless web of material 11, 12 can be conveyed. The end-to-end splice of the webs of material 11, 12 can therefore be produced at process speed, so that the speed of a subsequent process in the production of energy cells, in particular battery cells, does not have to be reduced for the joining process.

FIG. 13 schematically shows the webs of material 11, 12 joined by the adhesive tape 19 from a rear side. FIG. 14 shows the same join in a front view. In particular, it can be seen that the web end 15 of the running-out web of material 11 and the leading end 16 of the new web of material 12 comprise no overlap.

### LIST OF REFERENCE SIGNS

10 device
11 running-out web of material
12 new web of material
13 first pivoting element
14 second pivoting element
15 web end
16 leading end
17 cutting device
18 separating line
19 adhesive tape
20 running-out bobbin
21 new bobbin
22 bobbin holder
23 bobbin holder
24 turntable
25 bobbin opener
26 pretensioning element
27 leader
28 cutting unit
29 backing element
30 applicator
31 recess
32 supply unit
33 pivot axis
34 pivot axis
35 contact surface
36 contact surface

1. A device for joining webs of material for the production of energy cells wherein a running-out web of material can be joined to a new web of material (12), wherein
a first pivoting element for the new web of material and a second pivoting element for the running-out web of material are provided, wherein
the first pivoting element is adapted to hold a leading end of the new web of material,
the second pivoting element is adapted to deflect the running-out web of material in the direction of the first pivoting element, and
a cutting device is provided, which is adapted to cut or weaken the running-out web of material deflected by the second pivoting element to produce a web end of the running-out web of material at a separating line, wherein
the device is adapted to
to accelerate the leading end of the new web of material with the first pivoting element and to synchronize with the running-out web of material at the speed at which the web end of the running-out web of material deflected by the second pivoting element is conveyed, wherein
the leading end of the new web of material can be joined to the web end of the running-out web of material between the first and second pivoting elements by means of at least one adhesive tape.

2. The device according to claim 1, wherein
the leading end of the new web of material and the web end of the running-out web of material are joinable one behind the other between the first and second pivoting elements.

3. The device according to claim 1, wherein
the first pivot element and the second pivot element roll against each other in a joining section, wherein the new web of material and the running-out web of material are arranged one behind the other and are each arranged between the first pivot element and the second pivot element.

4. The device according to claim 1, wherein the second pivoting element is adapted to deflect the running-out web of material in a non-slip manner.

5. The device according to claim 1, wherein the second pivoting element is adapted to press the running-out web of material against the first pivoting element during deflection.

6. The device according to claim 1, wherein the running-out web of material can be clamped between the first pivoting element and the second pivoting element, while the running-out web of material can be conveyed further in a conveying direction.

7. The device according to claim 1, wherein the second pivoting element is a counter-holder for the running-out web of material when it is cut or weakened by the cutting device.

8. The device according to claim 7, wherein the cutting device is a knife roller which, during cutting or weakening, runs synchronously on the second pivoting element, wherein the running-out web of material runs between the second pivoting element and the cutting device.

9. The device according to claim 1, wherein the running-out web of material runs off a bobbin which is arranged on a bobbin holder, wherein the device is adapted to slow down the bobbin after weakening of the running-out web of material at the separating line in relation to the conveying speed.

10. The device according to claim 1, wherein a bobbin opener is arranged on the first pivoting element, which is adapted to open a bobbin with a new web of material and to pick up the leader of the new web of material from the bobbin.

11. The device according to claim 1, wherein a pretensioning element is provided for rolling up and tensioning the leader of the new web of material.

12. The device according to claim 1, wherein the device comprises a cutting unit and a backing element, wherein the cutting unit and the backing element are adapted to cut the new web of material to produce the leading end of the new web of material.

13. The device according to claim 12, wherein the cutting unit is arranged in a recess in a contact surface for the webs of material of the first pivoting element.

14. The device according to claim 1, wherein
an applicator for adhesive tape is arranged on the first pivoting element which is radially displaceable perpendicular to the pivot axis of the first pivoting element.

15. The device according to claim 14, wherein the applicator is arranged in a recess in a contact surface for the webs of material of the first pivoting element.

16. The device according to claim 14, wherein a supply unit for supplying adhesive tape is provided, which is adapted to transfer adhesive tape to the applicator.

17. A method for joining webs of material for the production of energy cells, wherein the method is carried out using the device according to claim 1.
